(19) United States
(12) Patent Application Publication
(10) Pub. No.: US 2007/0178286 A1
(43) Pub. Date: Aug. 2, 2007

(54) Free pattern tiles

(76) Inventor: Edward Albert Borlenghi, Huntington Beach, CA (US)

Correspondence Address: EDWARD ALBERT BORLENGHI;STE 206, 13011 NEWPORT AVE., TUSTIN, CA, 92780, US

(21) Appl. No.: 11/337,135

(22) Filed: Jan. 23, 2006

(51) Int. Cl. B32B 3/00; B32B 27/14

(52) U.S. Cl. 428/195.1; 428/196

(57) ABSTRACT

It is possible to cover a surface with a multitude of different patterns that are all created by the same tile. The tile has a design on it that follows the rules of expired U.S. Pat. No. 5,011,411. Whereby that patent describes the ability to achieve a non-repetitive surface cover design by placing the tiles side-by-side in a random configuration, this improvement allows for different patterns to be achieved depending on the rotations of the tiles in a predefined group that is repeated over the target surface.

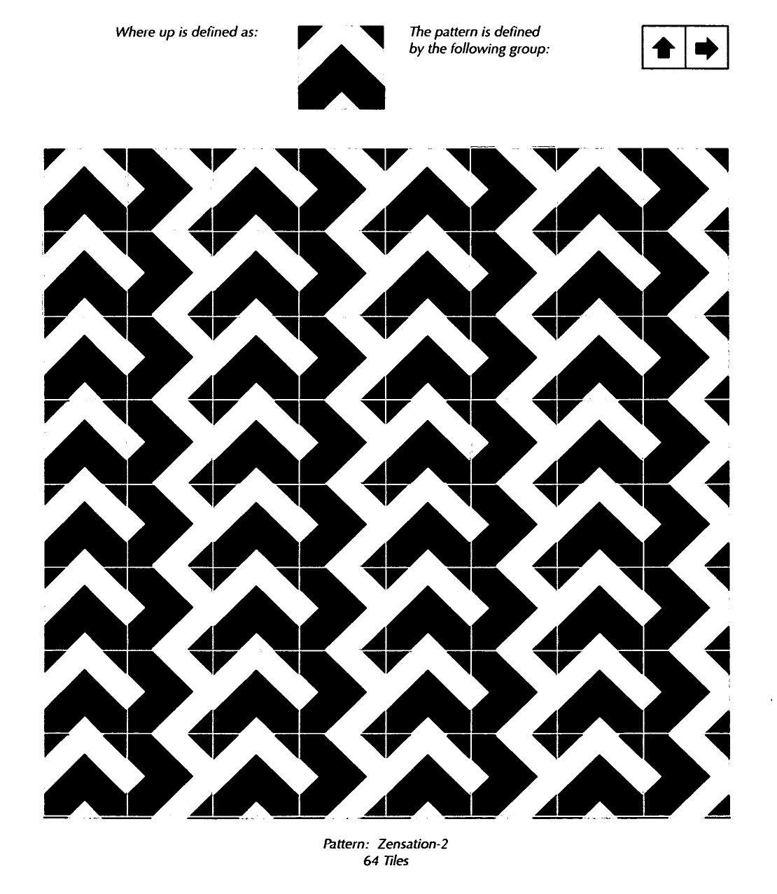

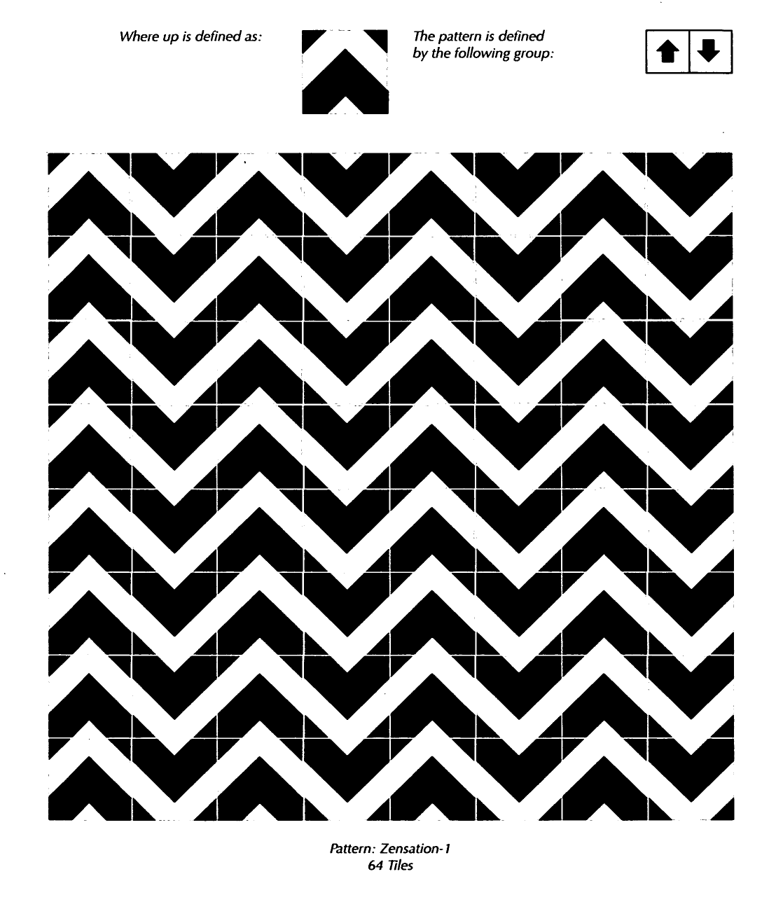

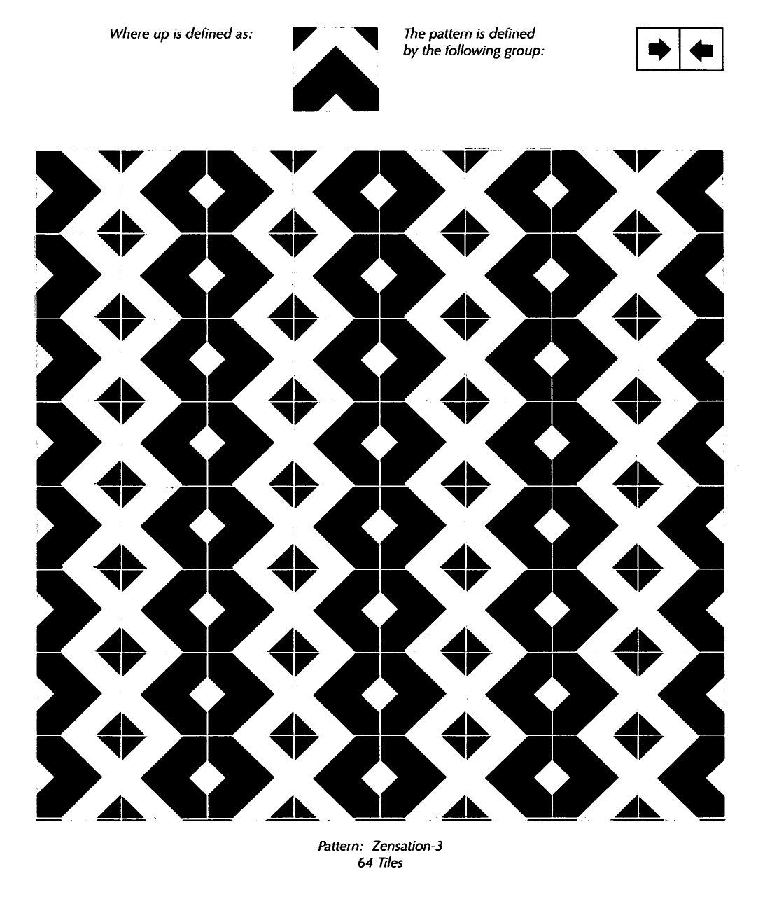

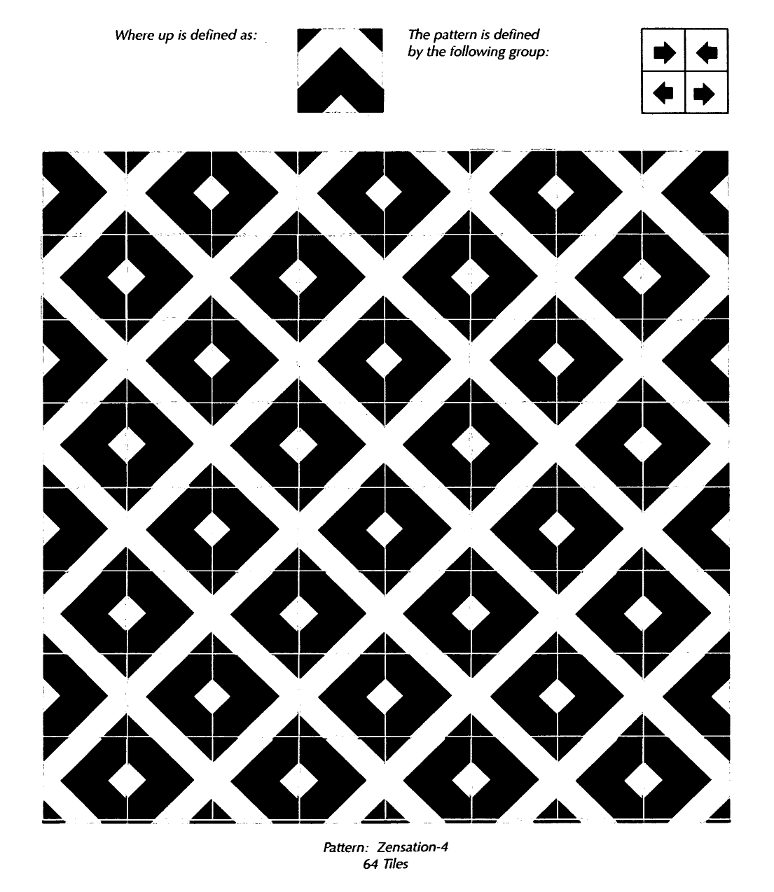

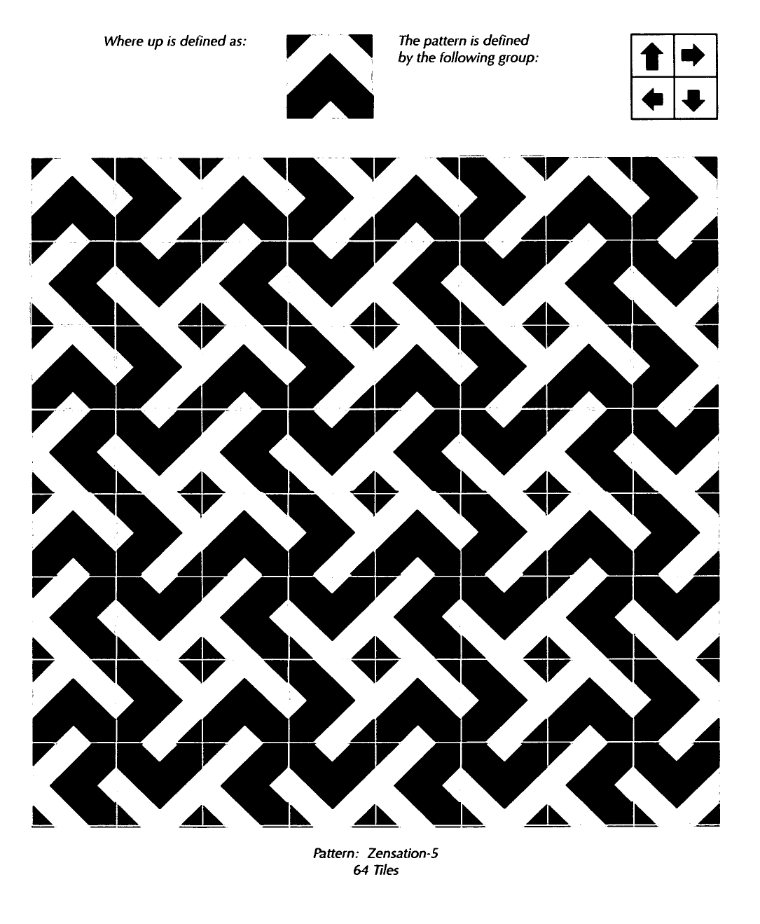

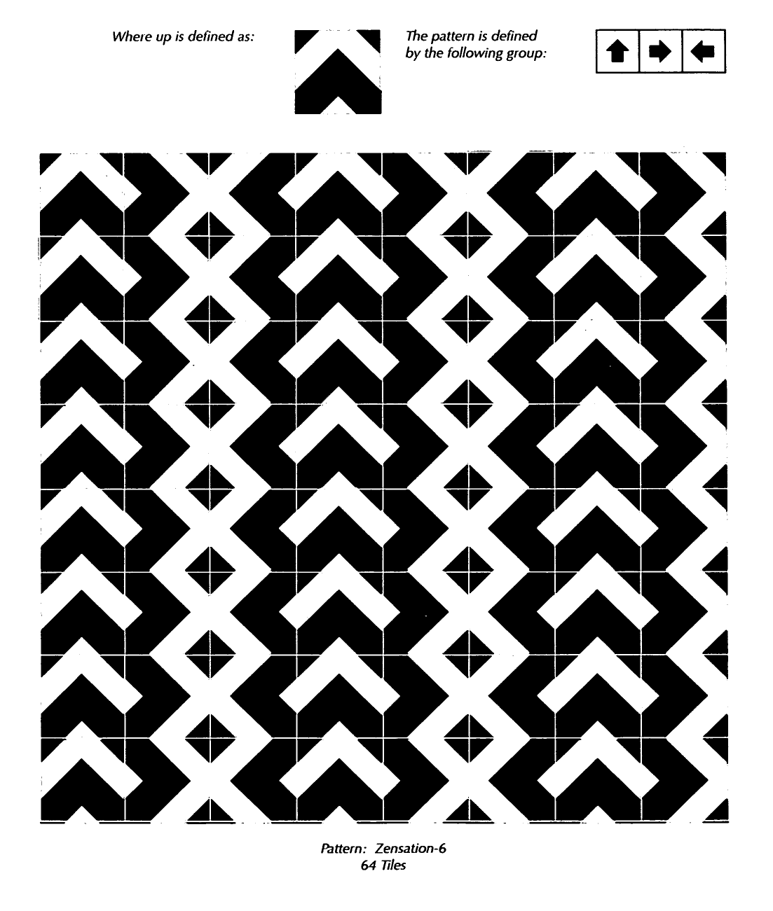

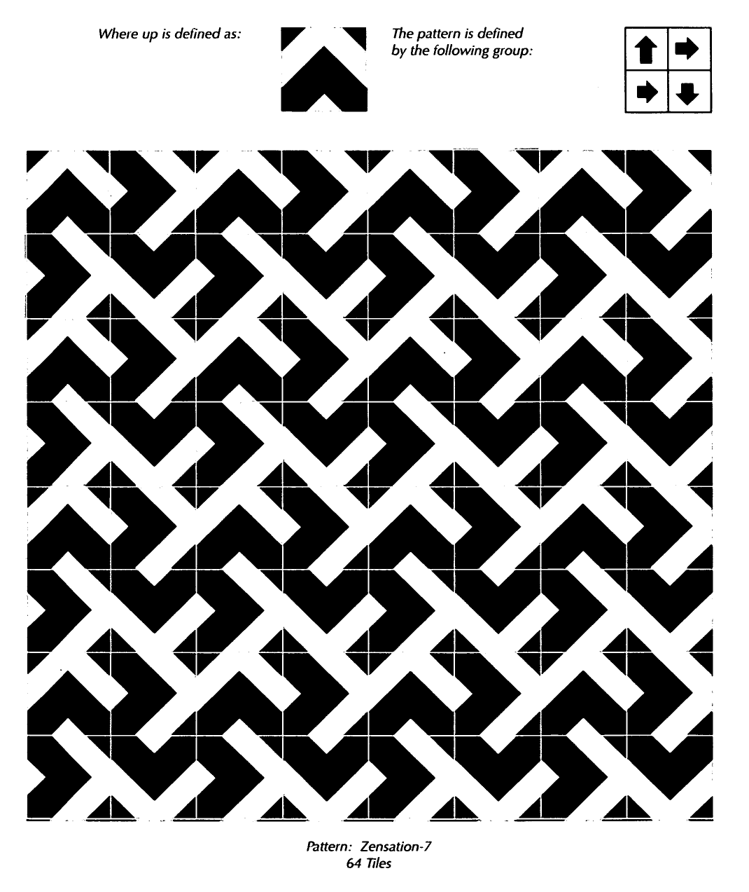

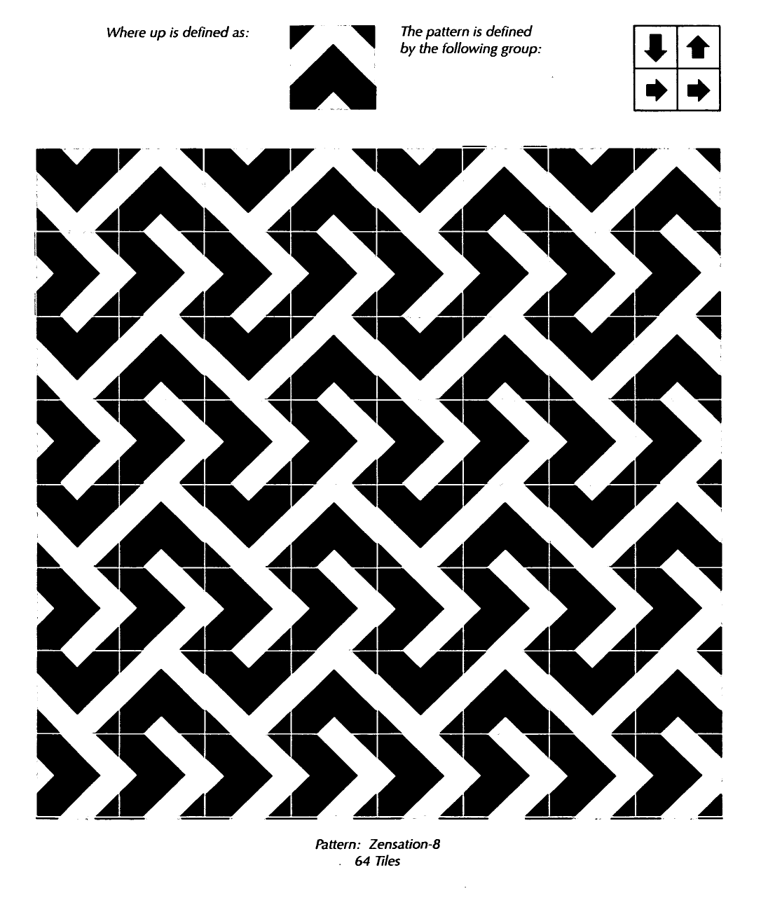

### CROSS-REFERENCE RELATED PATENT

U.S. Pat. No. 5,011,411 (A. Loewy) is an expired patent to which this application presents an improvement. Said improvement is not mentioned in any of the claims of aforementioned expired patent.

### BACKGROUND OF THE INVENTION

In 1992, while attending architecture school at Cal Poly, San Luis Obispo, I discovered an interesting method for designing a surface tile such that no matter how the tiles are rotated when placed next to each other, the design always matches from tile edge to tile edge, providing a surface that has a non-repetitive, flowing design. This concept was unique to me because all surface tiles that are available on the market are such that they always create a repetitive pattern.

The concept had such a great potential in the surface-covering field that I decided to make efforts to patent it a few years later. I met with a patent attorney who was equally intrigued by the idea, and submitted for a patent after conducting a brief, and consequentially ineffective, patent search. While “patent pending”, I produced some refrigerator magnets that exemplified the non-repetitive tile for decorative purposes. Soon after, my attorney conveyed to me that the patent was rejected because of a preexisting patent (that which is referenced above at “Cross-reference related patent”). Discouraged, I set aside the concept and stopped promoting my refrigerator magnets.

Unexpectedly, the patent holder, Andy (Andreas) Loewy, contacted me to find out if I was earning income off the idea. I explained that I was still at a fiscal loss due to the product production, and no longer intended to market the magnets since he had the patent. We got to talking and swapped stories on how we came up with the same idea.

Andy explained that he was teaching an architecture class when he discovered the concept, and I, coincidentally, explained that I was attending an architecture class when I discovered the concept. Clearly, it wasn't the same class since his discovery was in Louisiana in the late 1980's, and mine was in California in the early 1990's. Somehow, we both came up with the same idea, but he came up with it first, and successfully patented it.

While still speaking to him on the phone, I asked Loewy what he had done with the concept and why I haven't seen it yet on the market. He explained that he introduced it to several different construction industry professionals and toy makers, but nobody was interested in taking it on.

Despite Loewy's prior failure to launch the concept, and my discouragement at learning that somebody else held the patent for a concept that I also invented, I continued to consider possibilities for the invention. I decided to focus on the floor-covering industry since I did not get a fantastic response professionally nor publicly from the refrigerator magnet designs.

While working with a few of the designs that I determined worked well with the concept (after having discarded 100+less-effective tile designs), I realized that although a non-repetitive pattern can be achieved, there were also notable geometries like circles or squares (depending on the tile design) that presented themselves unintentionally when tiles were laid out randomly. These geometries became noticeable in a field of non-repetition, and they were merely a function of how the tiles were oriented next to one another. Therefore, the entire surface area that the files would cover would potentially have notable geometries and be at the whim of the installer. That is, although the tiles may be intended to create a random, non-repetitive pattern, an unsupervised installer could decided to rotate the files in a specific way to create recognizable geometries.

I decided to continue exploring the possibilities of the concept using my best tile designs. What I discovered is the foundation of this patent application. Instead of simply placing the tiles next to each other to achieve a non-repetitive surface, I could define a group of tiles and repeat the group. That is, I created a group of two tiles where their orientations were opposite, and repeated the group. This created a repetitive pattern. Likewise, I grouped three, four, six, etc. tiles in varying orientations, then repeated the group to create a different repetitive pattern. Essentially, I discovered that although the tiles can be installed randomly to create a non-repetitive surface cover, they can be grouped and repeated to create many different patterns. I spent more time analyzing my tile designs for use in this respect.

In order to better examine my findings, I developed a notebook full of different patterns created by my four most anticipatedly marketable tile designs, and subsequently copyrighted them in June of 2005 (VAU 676-680). Each style generated approximately twenty appealing designs, and more can still be created. It follows the simple rule illustrated at Claims. It was around this time that I discovered that Loewy let his patent expire.

### BRIEF SUMMARY OF THE INVENTION

Stemming from expired U.S Pat. No. 5,011,411 (A. Loewy), whereby a non-repetitive surface cover design can be achieved by placing specifically designed tiles side-by-side with random rotations, contrarily this improvement on the invention specifies that a multitude of patterns can be achieved by creating and repeating groups of said specifically designed tiles. That is, instead of installing tiles randomly for a non-repetitive surface design, they are installed by repetition of a predefined group for each pattern. Therefore, a surface cover that employs this type of tile design can either have a random, non-repeating overall design, or a multitude of varying patterns depending on the way the tiles are grouped upon installation.

### DETAILED DESCRIPTION OF THE INVENTION

Using the drawings included as part of this application as exemplary, each tile is constructed by a method established in expired U.S. Pat. No. 5,011,411. Such patent describes this method for designing a surface tile in order to assemble them next to one another with random or otherwise un-predefined rotations with respect to one another for the purpose of establishing an over-all surface cover design that is non-repetitive and not predesigned.

This invention, on the contrary, causes to be created a multitude of repetitive patterns by repeating a predefined group of said tiles. As shown in the eight drawings, different patterns are achieved by creating and repeating a small group of tiles. The drawings show groups ranging from two to four tiles, but patterns can be created by repeating larger groups of tiles.

### DRAWINGS

The following drawings, labeled 1/8 through 8/8 show eight different patterns that can be created using the tile style entitled “Zensation.” At the top of each drawing, one tile of Zensation stands alone, representing the orientation of the tile when in the “up” rotational position. At the top-right, there is a diagram showing a group of tiles, with quantities ranging 2 to 4, with arrows that represent the rotational direction of each tile in the group. The main body of each diagram represents the resultant pattern that is created by repeating the group of tiles defined at the top-right. The pattern is composed of 64 tiles.

1. As inventor of improvement to U.S. Pat. No. 5,011,411, I, Edward A. Borlenghi, claim that a multitude of patterns can be achieved for a surface design by grouping and repeating tiles whose surface design is constructed in accordance with the aforementioned patent.
